(19) United States
(12) Patent Application Publication
(10) Pub. No.: US 2015/0112577 A1
(43) Pub. Date: Apr. 23, 2015

(54) POWER-ECONOMY MODE CONTROL SYSTEM FOR A VEHICLE

(71) Applicants: Ramasamy Velusamy, Nashik (IN); Rehan Shaik, Nashik (IN)

(72) Inventors: Ramasamy Velusamy, Nashik (IN); Rehan Shaik, Nashik (IN)

(73) Assignee: Mahindra & Mahindra Limited, Nashik, MH (IN)

(21) Appl. No.: 14/404,481

(22) PCT Filed: Jun. 3, 2013
(86) PCT No.: PCT/IN2013/000349

§ 371 Date: Nov. 28, 2014

(30) Foreign Application Priority Data
Jun. 1, 2012 (IN) 1626/MUM/2012

(51) Int. Cl. F02D 41/30; G07C 5/08

(52) U.S. Cl. CPC F02D 41/3064; G07C 5/0808; F02D 2250/18
USPC 701/110

(57) ABSTRACT

The present invention is related to a vehicle provided with operation selection mode. In particular, the present invention is related to a common rail electronically controlled vehicle provided with operation selection mode wherein the user can select either of the power mode and the economy mode of vehicle operation depending on the road conditions. The system of the present invention provides a system to enable selection of power mode operation for power conscious driving requirement or economy mode operation for fuel conscious driving option obviating the use of additional interface devices between engine and engine control unit.

The present application is a national phase application filed for PCT/IN2013000349 dated 3 Jun. 2013, which claims priority from Indian Application Number 1626/MUM/2012, filed on 1 Jun. 2012, the disclosure of which is hereby incorporated by reference herein.

### TECHNICAL FIELD

The present invention is related to a vehicle provided with operation selection mode. In particular, the present invention is related to a common rail electronically controlled vehicle provided with operation selection mode wherein the user can select either of the power mode and the economy mode of vehicle operation depending on the road and load conditions.

### BACKGROUND

In the competitive and crowded vehicle market, cost of ownership of the vehicle has become one of the defining selection factors at the consumer end. The effective cost of the vehicle is predominantly dependent on the initial and the operation/running cost of the vehicle. The operational cost is mainly dependents on the fuel consumption per unit distance, as it relates directly to the engine performance. .

However the engine torque, speed and power output define the driving mode of the vehicle. The vehicle needs to be operated in a dynamic mode in which the parameters have to be optimized for minimal fuel consumption. Typical driving tracks such as in Ghats i.e. on uphill roads with series of bends, and conditions such as overtaking, high power is preferable but the engine operated in a minimal fuel consumption mode.

The challenge and the unmet need have been to provide an engine system that meets the varying requirements, offer choice to the end user of selecting and operating in power or economic mode, in a relatively system simple obviating the need for complex constructions, interfaces and yet achieving the desired fuel economy and enhanced performance.

Prior Art discloses several systems but have failed to comprehensively meet the above requirements.

U.S. Pat. No. 7,490,000 discloses a fuel economy control module with associated logic that allows the vehicle to operate in a fuel economy mode based on a desired fuel economy preference. The fuel economy control logic is in electrical communication with a vehicle system controller and may be integrally formed as a sub-module within the vehicle system controller. A fuel economy control switch controlled by the fuel economy control logic toggles between an on and an off position to enable or disable a fuel economy mode. This related to a fuel economy control system and strategy for an alternative fuel vehicle such as an electric, a hybrid electric, or a fuel cell vehicle, by a switching functions depending upon a multitude of inputs on the vehicle operating conditions. However this system suffers from complexity, it comprises of an electric, a hybrid electric, or a fuel cell vehicle for its operation.

JP2005214086A discloses eco-friendly power drive device wherein communication interface is connected to the microcomputer equipped with the keyboard switch and the indicator. It controls the air fuel ratio using the fuel-injection-quantity-regulating-function in the engine control unit of the vehicle. Fuel-injection control is corrected by the travelling driving working state of vehicle. The microcomputer connected to the engine control unit of said vehicle through a communication interface has a vehicle-type discrimination function. It connects to the engine control unit of any vehicle through a communication interface, a fuel-injection-quantity correction can be appropriately selected and performed for that vehicle type.

This system disclosed in JP2005214086A suffers from drawbacks such as (i) need of an interfacing unit in between the Engine ECU and Input switch; (ii) Average capability of a vehicle specification at the time of factory shipments; (iii) Switch over from ECO to Normal to Power is dependent on Pedal position; (iv) Factory setting is sub optimal, More complex system, More reliability issues, Safety issues as switching is dependent upon Acceleration Pedal; (v) Use of complex algorisms adding to the failure modes, requires lot many inputs for effective functioning; (vi) Limited to gasoline vehicles, (vii) need of physical Linkages leading more number of parts and in turn reliability issues.

Japanese patent. JP2011196346A discloses a vehicle apparatus. It operates in a mode when the control apparatus is switched to the low-fuel-consumption mode. The information of the state of the vehicle is acquired by the vehicle status information acquisition means. The engine power of the said vehicle exists in a condition with required raising rapidly, the signal made to be switched from the said low-fuel-consumption mode to a said normal mode is output to the said control apparatus. The system disclosed suffers from the drawback that extensive vehicle data (gradient, engine speed, distance to previous vehicle, 1st relative velocity of the previous vehicle, highway main line, maps to limit vehicle rapidly raising phenomena to save the fuel consumption.

U.S. Pat. No. 8,224,560 disclose eco-drive Support Device and Method of notification to the driver to use eco drive based on the multiple inputs. However the system requires road information, requires continuous information from accepted on its position and many more inputs requires to notify the user.

U.S. Pat. No. 8,352,150 discloses engine control apparatus comprising driving-state detection (accelerator opening-degree change rate i.e. amount of actuation of acceleration pedal), storage means (for storing the mode maps), the engine control modes (3 modes—power mode, save mode and a normal mode). One of the engine control modes are selected on the basis of vehicle speed and a weighted average sums of parameters corresponding to plurality of events based on driving state detected. This system suffer from the drawback that it needs intricate algorithms involving multiple inputs from various sensors in the vehicle.

### SUMMARY

The main object of the present invention is to provide power or economy mode selection and control system for an automotive vehicle.

Further object of the invention is to provide a system and method to enable selection of power mode operation for power conscious driving requirement or economy mode operation for fuel conscious driving option obviating the use of additional interface devices between engine and engine control unit.

Another object of the invention is to effectively utilize functionality of already existing sensors, actuators and controllers of the engine and vehicle system to enable a variant mode of engine vehicle to operate on economic or power mode for enhanced performance. Another object of the invention is to provide a system to enable regulation of torque delivery profile for power as well as economic mode operation to achieve fuel saving.

Another object of the invention is to enable substantial fuel saving and enhanced performance with minimum additional components/devices and input information for economic and or power mode function of the vehicle.

Another object of the present invention is to provide a method of controlling engine output torque at various/multiple mode of operation depending upon user requirement by only switching operation.

Yet another object of the present invention is to provide a system with real time driving option to drive the vehicle in power or economy mode.

Another object of the invention is to obviate use of additional interface devices between engine and engine control unit along with multiple sensor information to enable power economic mode function.

Another object of the invention is to obviate intricate additional algorithms to achieve/activate the Power-Eco mode of operation.

Yet another object of the invention is to regulate/control air fuel ration as per the economic mode requirement.

Yet another object of the invention is to set the optimum or best performance from factory settings wherein fuel saving mode is aimed at.

Another object of the invention is to enable switching of the mode based on the driver input.

Yet another object of the invention is to obviate dependence of economic or power mode on acceleration pedal position.

Yet another object of the invention is to obviate additional linkage mechanisms relating to acceleration pedal.

Another object of the invention is to obviate inputs to the ECU in the form of acceleration pedal position to operate the vehicle in a particular mode. Further object of the invention is to provide flexibility to the driver to select mode of operation using the toggle switch that is independent of the acceleration pedal position.

Yet another object of the invention is to provide a single Electronic Control Unit for the operation of both the power and economic mode.

### BRIEF DESCRIPTION OF THE FIGURES

The objectives and advantages of the present invention will become apparent from the following description of the preferred embodiments.

FIG. 1 is a configuration layout schematically showing the entire structure of a vehicle power train into which an ECU in accordance with a first embodiment of the present invention is incorporated.

FIG. 2 shows the block diagram of the operation mode control system of the present invention.

FIG. 3 shows the CLOSE position of the selector switch in the operation mode control system of the present invention.

FIG. 4 shows the OPEN position of the selector switch in the operation mode control system of the present invention.

FIG. 5 shows the working flow chart of the system in accordance with the present invention.

FIG. 6 shows the engine output curves (RPM vs Torque) in economy mode in accordance with the present invention.

FIG. 7 shows the engine output curves (RPM vrs Torque)—Type 2 in accordance with the present invention.

FIG. 8 shows the engine output curves (RPM vrs Torque)—Type 3 in accordance with the present invention.

FIG. 9 is a plot showing the difference in the performance between the two modes of operation of the present invention i.e. Power and Economy underlining the energy saving feature in accordance with the first embodiment.

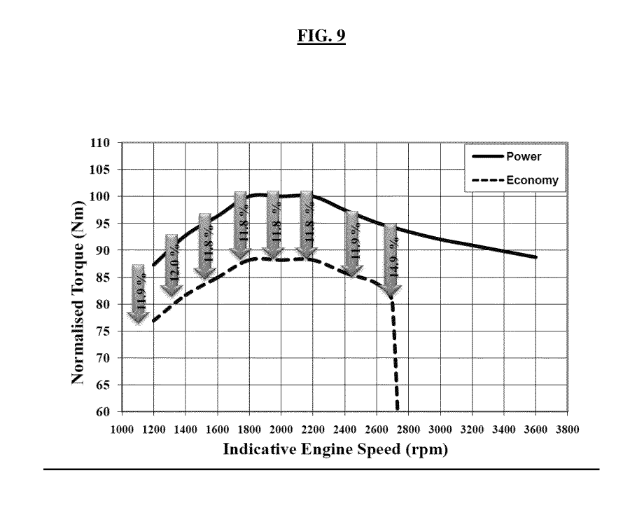

### DETAILED DESCRIPTION

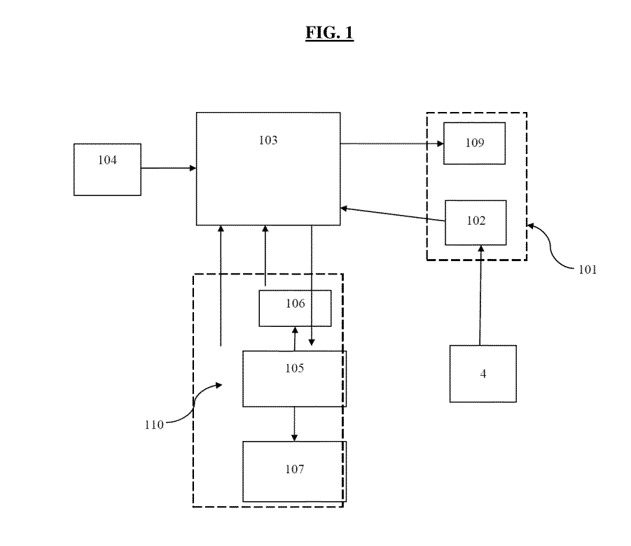

FIG. 1 illustrates the configuration of the system to enable power and economy mode operations. It comprises of power train 110, electronic control unit 103, mode selection switch 102, accelerator pedal input 104, and mode indication lamp 109. The power train unit 110 comprises of engine 105, engine speed sensor 106 and transmission unit 107. The mode selection switch 102 and indication lamp 109 are adapted to be mounted on the vehicle dashboard instrument panel cluster 101. The said electronic control unit is operably configured with the engine speed sensor 106, engine 105, accelerator pedal mechanism 104 and mode selection switch 102. The driver of the vehicle selects the desired mode (power or economy) by operating the said selection switch 102. The input from the said switch is fed to the said electronic control unit 103 to process it wherein the said unit operates to send a signal to the engine to switch over the mode. The active mode of operation (power/economy) is indicated by the system by enabling visual indication with the aid of indication lamp 109 mounted on the dashboard of the vehicle.

The ECU (103) comprises an analog signal conditioner, digital signal conditioner, CPU, program memories namely EPROM and E2PROM, power stage controller, CAN, and diagnostics and alarms. The inputs to the ECU typically include engine speed, CAM PHASE, coolant temperature, accelerator pedal position, air mass flow, air temperature, boost pressure, brake switch, clutch switch, air conditioning , battery, etc. The output from the ECU includes actuation of injector, metering unit, EGR, boost pressure, radiator fan, glow plug, etc. The diagnostic functions include high coolant temperature warning, low battery voltage warning etc.

Power mode (PWR) and Economy mode (ECO) are the two indications corresponding to the two modes of driving. Power mode operation refers to the vehicle operation with power conscious driving requirement while economy mode operation gives one more option of fuel conscious driving requirement. The shifting between the two different modes is facilitated with a help of a switch depending on driving conditions.

A 2D Power Mode Map of the engine is generated and stored in the EPROM. Further a 2D Economic Mode Map is generated and stored in the EPROM.

The 2D Power map is a relationship of engine speed and maximum fueling in power mode for 100% accelerator pedal position.

The 2D Economy Map is a relationship of engine speed and maximum fueling/torque in economic mode for 100% accelerator pedal position.

The power economy modes of operation are selected based on driving requirements in the form of driver's input through Power Economy Switch 102. According to the input, respective indication appears i.e. PWR/ECO in the form visible display 109 on the vehicle dash board/Instrument Panel Cluster 101.

On input from the driver and the feedback from engine speed sensor 106, ECU refers to the 2D Power Map and selects the predefined fueling for a particular engine speed at 100% accelerator pedal, actuates the injector to supply the selected quantity of fuel to the engine to run in the power mode.

On input from the driver and the feedback from engine speed sensor 106, ECU refers to the 2D Economic Map and selects the predefined fueling/torque for a particular engine speed at 100% accelerator pedal, actuates the injector to supply the selected quantity of fuel to the engine to run in the economy mode.

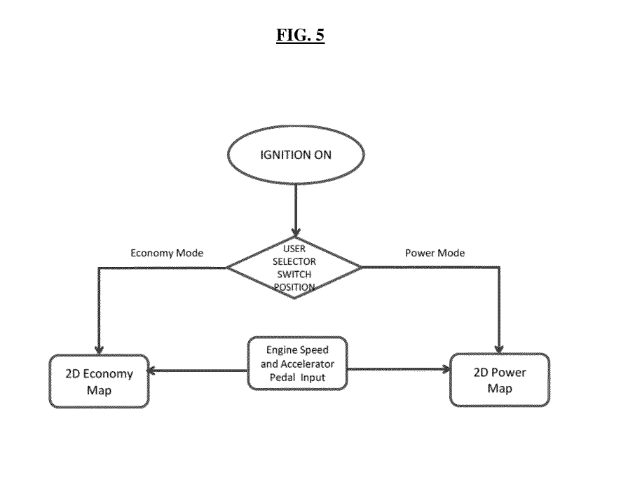

FIG. 5 illustrates the process steps comprising
activation of ignition;
allowing user selector switch operation
activating desired mode
receiving signal relating to the selection of power economy modes of operation based on driving requirements in the form of driver's input through power economy switch 102;
display of the indication in the form visible display (109) on the vehicle dash board (101) according to the said input;
acquiring feedback from engine speed sensor (106) and feeding it to the said ECU;
processing the 2D Power Map (or Economy Map as per the mode selection) in the ECU to select the predefined fueling for a particular engine speed at 100% accelerator pedal;
sending the signal to actuate engine injector to supply the selected quantity of fuel to the engine to run in the power mode.

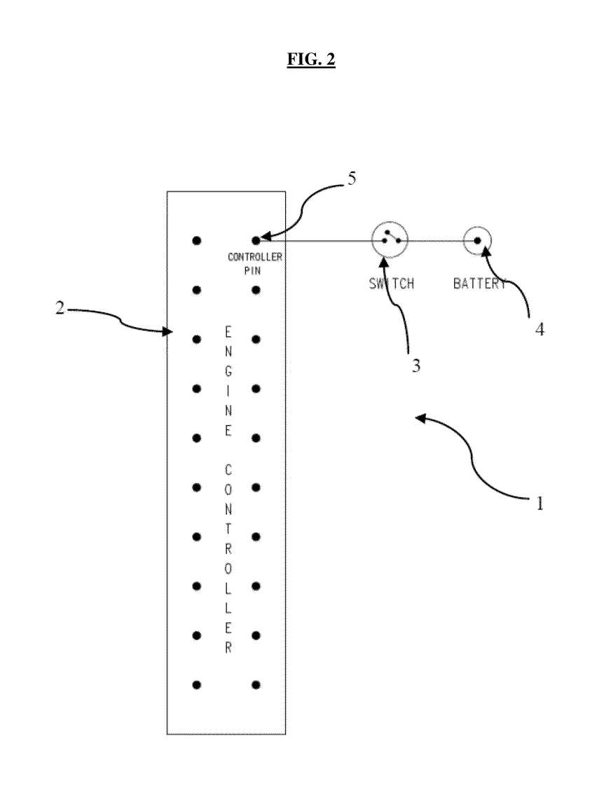

As indicated in FIG. 2, electronic control unit 2 is configured with selector switch 3 and the main battery 4 of the vehicle. A selection switch 3 is introduced in between the controller Pin 5. The said pin 5 is adapted based on the actuation of the economy mode. The ECU (2) is connected to the various sensors and actuators on the engine and vehicle by a series of electrical wires (collectively called as wiring harness). The said switch 3 is mounted on the vehicle dashboard and is introduced in series with the battery and ECU.

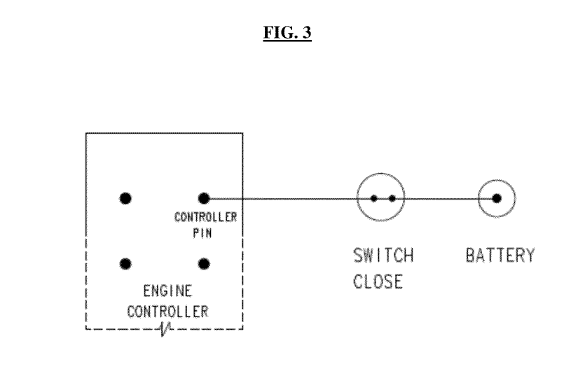

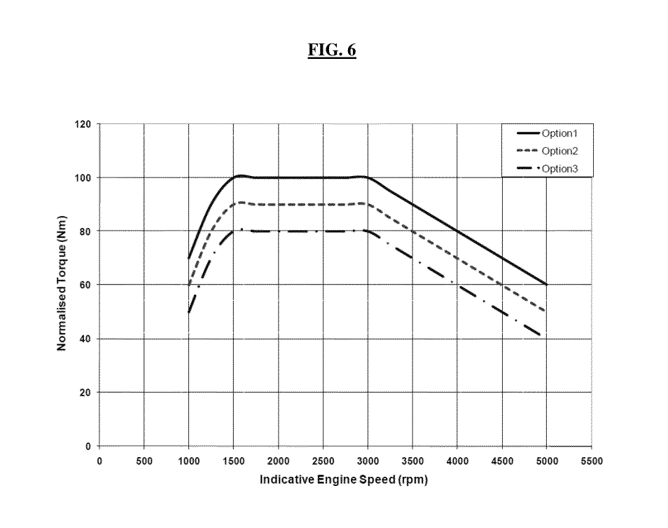

As depicted in FIG. 3, the selector switch 3 is in CLOSED position. The electronic control unit 2 is activated to sense that all functions are closed and allows engine/vehicle to operate under power mode characterized by Option 1 as represented in FIGS. 6, 7 and 8. It is to be noted that the representations in FIGS. 6, 7 and 8 are provided for comprehending the nature of the engine torque curve and is not indicative and limited to the actual values of the torque and rpm of particular engine.

The Option 1 is characterized by the maximum possible torque (Normalized to 100) that can be produced of an engine. In the power mode, the system retains the existing engine torque thereby retaining the best performance.

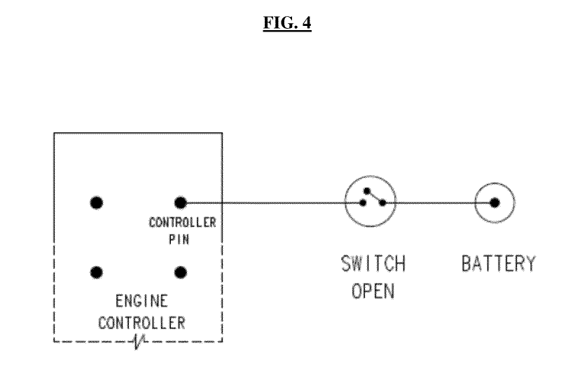

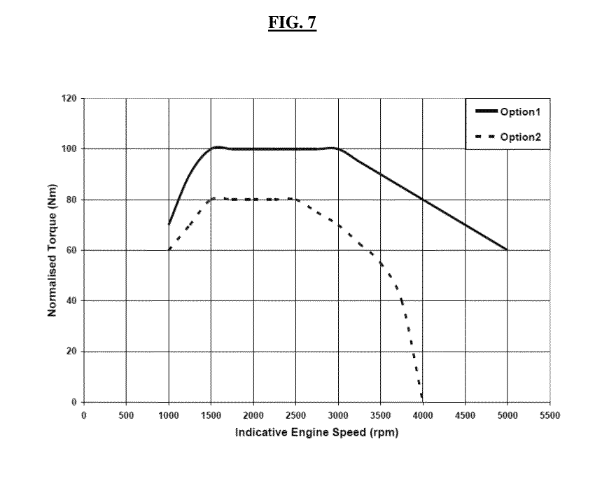

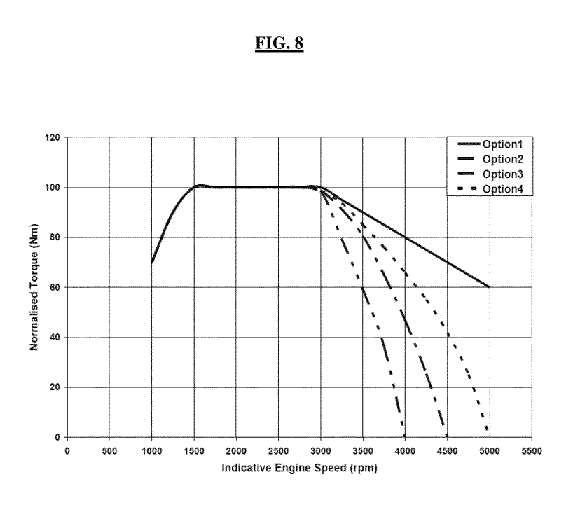

FIG. 4 depicts the OPEN position of the selector switch 3. When the selector switch (3) is in the OPEN condition, the ECU (2) activates the 2D Economy Map, selects the predefined fueling/torque as set in the Map thereby enabling the engine output in accordance with engine torque options 2, 3, and 4 as illustrated in FIGS. 6, 7 and 8:
The options for economy mode are including but not limited to degrading (reduction of torque), derating (reduction of engine rated speed).
In Option 2 and 3 as illustrated in FIG. 6, the torque of the engine is proposed to be reduced at the entire speed range of the engine.
In option 2 as depicted FIG. 7, torque as well as the speed of the engine is reduced.
In option 2, 3, 4 shown in FIG. 8, the peak torque is same as that of the normal mode, but engine speed is reduced.
The reduction can take place in three different characterizations as shown in FIGS. 6, 7, and 8, in terms of peak torque and rated speed, thus gaining on fuel consumption.
Fuel economy gains of 10-15% in the economy mode of operation as validated in on-road vehicle testing.

The engine controller 2 is enabled in the power mode if the selector switch 3 is in close position. Similarly, the engine controller is enabled in the economy mode if the selector switch 3 is in the open position.

It is evident that the present invention as compared to the prior art, does not need any additional interface devices between engine and engine control unit and multiple sensor information to achieve the power/economy mode operations. Further it does not require complex algorithms to be built into the system to achieve/activate the Power/Economy mode of operation.

It is to be appreciated that the present invention achieves fuel efficiency enhancement of 10-15% as validated in on-road conditions.

It should be understood that the present invention is not to be limited by the exact details of the illustrated embodiment. However, it is to be taken as the preferred example of the invention and that various changes may be resorted to by a person skilled in the art without departing from the spirit of the invention. Also, the terminologies used herein are for the purpose of description and should not be regarded as limiting.

We claim:

1. A power-economy mode control system for a vehicle, said system comprising:
a power train (110), an electronic control unit (103), a mode selection switch (102), an accelerator pedal input (104), a mode indication lamp (109) that is adapted to be mounted on the vehicle dashboard; said electronic control unit (103) comprising:
an analog signal conditioner, a digital signal conditioner, a CPU, a plurality of program memories, an EPROM, an E2PROM, a power stage controller, a CAN, a diagnostics, a plurality of alarms, wherein said electronic control unit is operationally configured with an engine speed sensor (106), an engine (105), the accelerator pedal mechanism (104) and the mode selection switch (102), wherein upon selection of at least a desired mode by operating said mode selection switch (102) by a driver of the vehicle, the input from said switch is fed to said electronic control unit (103) to process to send a signal to the engine to switch over the mode.

2. The power-economy mode control system for a vehicle as claimed in claim 1 wherein the inputs to the ECU comprises:
an engine speed, a CAM PHASE, a coolant temperature, an accelerator pedal position, an air mass flow, an air temperature, a boost pressure, a brake switch, a clutch switch, an air conditioning, a battery;
the output from the ECU comprises actuation of injector, metering unit, EGR, boost pressure, radiator fan, glow plug; and
the diagnostics comprises high coolant temperature warning, low battery voltage warning.

3. The power-economy mode control system for a vehicle as claimed in claim 1 wherein said EPROM is stored with a 2D Power Mode Map and 2D Economic Mode Map of the vehicle engine wherein the 2D Power map is a relationship of engine speed and maximum fueling in power mode for 100% accelerator pedal position; the 2D Economy Map is a relationship of engine speed and maximum fueling torque in economic mode for 100% accelerator pedal position.

4. The power-economy mode control system for a vehicle as claimed in claim 1, wherein system operates to enable power mode of the vehicle, said mode comprising:
activation of ignition;
allowing user selector switch operation;
receiving signal relating to the selection of power economy modes of operation based on driving requirements in the form of driver's input through power economy switch 102;
display of the indication in the form visible display (109) on the vehicle dash board (101) according to the said input;
acquiring feedback from engine speed sensor (106) and feeding it to the said ECU;
processing the 2D Power Map in the ECU to select the predefined fueling for a particular engine speed at 100% accelerator pedal; and
sending the signal to actuate engine injector to supply the selected quantity of fuel to the engine to run in the power mode.

5. The power-economy mode control system for a vehicle as claimed in claim 1, wherein system operates to enable economy mode of the vehicle said mode comprising:
activation of ignition;
allowing user selector switch operation;
receiving signal relating to the selection of power economy modes of operation based on driving requirements in the form of driver's input through power economy switch 102;
display of the indication in the form visible display (109) on the vehicle dash board (101) according to the said input;
acquiring feedback from engine speed sensor (106) and feeding it to the said ECU;
processing the 2D Economy Map in the ECU to select the predefined fueling for a particular engine speed at 100% accelerator pedal; and
sending the signal to actuate engine injector to supply the selected quantity of fuel to the engine to run in the economy mode.

6. The power-economy mode control system for a vehicle as claimed in claim 1, wherein the said electronic control unit (2) is configured with selector switch 3 and the main battery (4) of the vehicle, wherein a selection switch (3) is introduced in between the pin (5);
the ECU (2) is operationally connected to the various sensors and actuators; and
the said switch (3) is mounted on the vehicle dashboard and is introduced in series with the battery and ECU.

7. The power-economy mode control system for a vehicle as claimed in claim 6 wherein upon activation of the said selector switch (3) in CLOSED position, the electronic control unit (2) is activated to sense that all functions are closed and allows engine of the vehicle to operate under power mode characterized by the maximum possible torque that is normalized to 100 that can be produced by an engine, wherein the system retains the existing engine torque thereby retaining the best performance.

8. The power-economy mode control system for a vehicle as claimed in claim 6 wherein upon activation of the said selector switch (3) in OPEN position, the ECU (2) activates the 2D Economy Map, selects the predefined fueling/torque as set in the Map thereby enabling the engine output in accordance with engine torque options.

9. The power-economy mode control system for a vehicle as claimed in claim 1, wherein the said operation mode control system functions in power mode to reduce engine torque at the entire speed range of the engine.

10. The power-economy mode control system for a vehicle as claimed in claim 1, wherein the said operation mode control system functions in economy mode to reduce torque and reduce engine rated speed.

11. The power-economy mode control system for a vehicle as claimed in claim 1, wherein the said operation mode control system functions to maintain the peak torque constant as that of the normal mode and engine speed is reduced.

12. The power-economy mode control system for a vehicle as claimed in claim 1, wherein upon activation of the mode selection switch (102) by the driver of the vehicle, the system operates to send the signal to the said electronic control unit (103) to process it wherein the said electronic control unit (103) further operates to send a signal to the engine to switch over the mode;
the active mode of operation (power/economy) is indicated by the system by enabling visual indication with the aid of indication lamp (109) mounted on the dashboard of the vehicle, wherein the said electronic control unit (103) comprises of an analog signal conditioner, digital signal conditioner, CPU, program memories EPROM, E2PROM, power stage controller, CAN, diagnostics, alarms, wherein the said electronic control unit is operationally configured with the engine speed sensor (106), engine (105), accelerator pedal mechanism (104) and the mode selection switch (102) wherein EPROM is stored with a 2D Power Mode Map and 2D Economic Mode Map of the vehicle engine, the 2D Power map is a relationship of engine speed and maximum fueling in power mode for 100% accelerator pedal position; and
the 2D Economy Map is a relationship of engine speed and maximum fueling/torque in economic mode for 100% accelerator pedal position.
